(19) United States
(12) Patent Application Publication
(10) Pub. No.: US 2025/0309401 A1
(43) Pub. Date: Oct. 2, 2025

(54) GAS COOLER WITH INTEGRATED BYPASS

(71) Applicants: Hanon Systems, Daejeon (KR); HANON SYSTEMS EFP DEUTSCHLAND GMBH, Bad Homburg v.d. Höhe (DE)

(72) Inventors: Jan Hinrichs, Friedrichsdorf (DE); Andreas Emmerich, Aachen (DE)

(21) Appl. No.: 19/041,309

(22) Filed: Jan. 30, 2025

(30) Foreign Application Priority Data
Mar. 28, 2024 (DE) 102024109068.5
Dec. 19, 2024 (DE) 102024138893.5

(51) Int. Cl. H01M 10/6556; H01M 10/613; H01M 10/625; H01M 10/6554; H01M 10/6568; H01M 10/6569

(52) U.S. Cl. CPC H01M 10/6556; H01M 10/613; H01M 10/625; H01M 10/6554; H01M 10/6568; H01M 10/6569

(57) ABSTRACT

A gas cooler for a battery electric vehicle, the gas cooler including a heat exchanger having a connecting portion and a heat exchange portion, the connecting portion including a coolant inlet to allow a coolant to enter the heat exchanger, and a coolant outlet to allow the coolant to exit the heat exchanger, wherein the gas cooler further includes a bypass line configured to redirect a portion of the coolant from the coolant inlet to the coolant outlet, thereby bypassing the heat exchange portion of the heat exchanger.

### CROSS REFERENCE TO RELATED PATENT APPLICATIONS

This patent application claims the benefit of and priority to German Patent Application No. 102024138893.5, filed on Dec. 19, 2024 and German Patent Application No. 102024109068.5, filed on Mar. 28, 2024, the entire contents of each of which are incorporated herein by reference for all purposes.

### TECHNICAL FIELD

The present invention relates to the field of gas coolers for use in heat pump systems for battery electric vehicles, abbreviated as BEVs.

### BACKGROUND

In heat pump systems for BEVs, a compressor compresses a refrigerant causing the temperature of the refrigerant to increase. In order to reduce the temperature of the compressed refrigerant, an integrated discharge gas cooler is provided. As the coolant for the gas cooler, a water-glycol mixture can be used. The gas cooler can be designed as a plate heat exchanger.

Under certain operating conditions, the coolant can reach temperature values that are too high for the subsequent components that control the coolant flow. On the other hand, a high coolant temperature is desired to increase efficiency of the heat pump system.

### SUMMARY OF THE INVENTION

An object of the present invention is to overcome the above-described problem to thereby increase the system efficiency of the heat pump system of the BEV without raising the coolant outlet temperature above a critical level.

This object is achieved by a bypass line in a gas cooler as disclosed herein. Preferred features are also disclosed.

A bypass line is integrated into the refrigerant/coolant heat exchanger. The bypass line is located between a coolant inlet of the heat exchanger and a coolant outlet of the heat exchanger, also referred to as the connecting portion, to thereby bypass elements of the heat exchanger which predominantly serve to exchange heat, also referred to as the heat exchange portion.

Through the bypass line, a portion of the coolant flow can be redirected from the coolant inlet directly to the coolant outlet. As a result, a portion of the coolant flowing in the coolant inlet and having a relatively low temperature can be mixed with the coolant coming from the heat exchanger, flowing in the outlet and having a relatively high temperature. Accordingly, the bypass line reduces the overall temperature of the coolant downstream of the outlet of the heat exchanger. The temperature of the coolant that has flowed through the heat exchanger is, by mixing it with coolant directly from the inlet side and bypassing the heat exchanging elements of the heat exchanger, i.e., coolant that has not yet flowed through the heat exchanger, reduced in accordance with the ratio of the relatively cold and the relatively hot coolant, i.e., the mixing temperature. The outlet coolant temperature is set as the mixing temperature of the partial volume flows.

By providing at least one cut-out or recess in at least one plate or a few plates of the plate heat exchanger and by redirecting the path several times, a bypass with a large flow cross section can be created that is insensitive to dirt particles so that the gas cooler becomes particularly reliable.

A gas cooler for a battery electric vehicle according to the present invention includes a heat exchanger having a connecting portion and a heat exchange portion. The connecting portion comprises a coolant inlet to allow a coolant to enter the heat exchanger, and a coolant outlet to allow the coolant to exit the heat exchanger. According to the invention, the gas cooler further comprises a bypass line configured to redirect a portion of the coolant from the coolant inlet to the coolant outlet, thereby bypassing the heat exchange portion of the heat exchanger.

The bypass line is functionally located between an inlet port and an outlet port, which means that the coolant can bypass the heat exchange portion within the gas cooler which can be connected to an upstream side and a downstream side of the heat pump circuit as usual. This way, it is efficiently possible to mix coolant from the inlet side with coolant leaving the heat exchanger. The coolant outlet temperature can thereby be set as the mixing temperature of the partial volume flows through the bypass line and the heat exchange portion of the heat exchanger.

Preferably, the heat exchanger is a plate heat exchanger. A plate heat exchanger is a particularly efficient heat exchanger in the context of BEVs and is particularly suited for providing a bypass according to the present disclosure.

Optionally in this case, the bypass line is formed as a recess or cut-out in at least one plate of the plate heat exchanger, the recess or cut-out fluidly connecting the coolant inlet with the coolant outlet. By forming a recess or cut-out in one plate or a few plates of the plate heat exchanger, it is possible to redirect the path of the coolant through the bypass several times. This allows for a bypass with a large flow cross section which, at the same time is insensitive to dirt particles so that the gas cooler becomes particularly reliable.

Optionally, the gas cooler further comprises a connection block having a bypass line fluidly connecting the coolant inlet with the coolant outlet, thereby bypassing the heat exchanger. This way, it is possible to avoid modifying the heat exchanger by providing a separate section of the gas cooler for the bypass whilst still allowing coolant from the inlet port to mix with coolant exiting the heat exchanger to thereby moderate the maximum temperature of the coolant whilst keeping the coolant temperature high enough for the heat pump system to work efficiently.

Preferably, the gas cooler is configured for the coolant being a mixture of water and glycol. This coolant is particularly suitable for an automotive heat pump system.

In a preferred embodiment, the heat exchange portion has a circular shape when viewed from above.

Preferably, openings are provided in the heat exchange portion to allow gas to pass through the heat exchange portion.

Optionally, the connection portion has a shape of two partially circular portions extending from the heat exchange portion when viewed from above.

Advantageously, the coolant inlet includes a coolant inlet port for connecting a coolant supply line of a heat pump circuit to the coolant inlet.

Optionally, the coolant outlet comprises a coolant outlet port for connecting a coolant discharge line of a heat pump circuit to the coolant outlet.

### BRIEF DESCRIPTION OF THE DRAWINGS

FIG. 1 illustrates a first embodiment of a preferred gas cooler.

FIG. 2 depicts the embodiment of FIG. 1 where the coolant inlet and outlet ports and the top plate are removed.

FIG. 3 is an enlarged view of the embodiment of FIGS. 1 and 2.

FIG. 4 is an enlarged sectional view of the embodiment of FIGS. 1 to 3.

FIG. 5 illustrates a second embodiment of a preferred gas cooler.

### DETAILED DESCRIPTION OF PREFERRED EMBODIMENTS

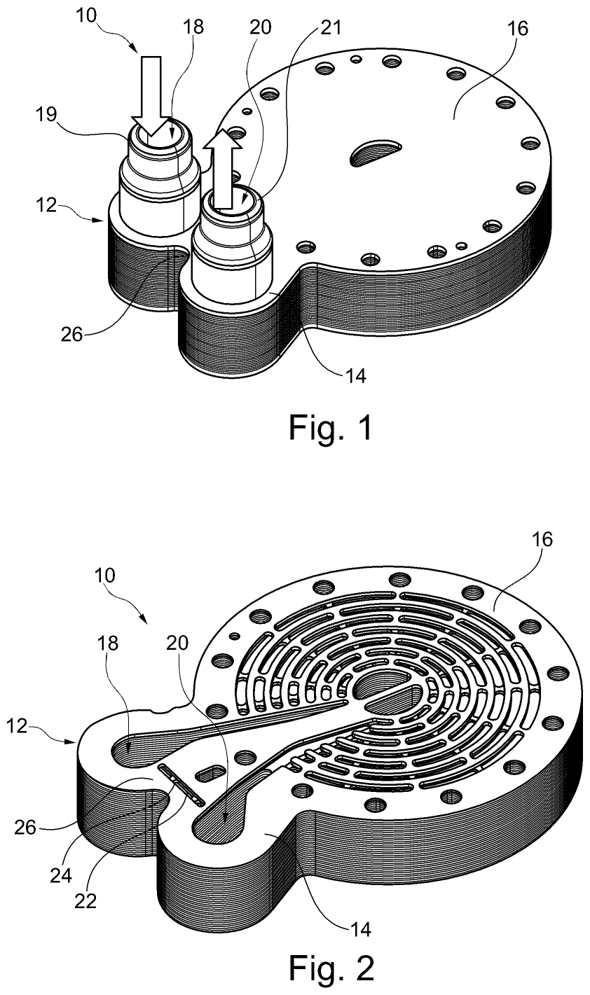

FIG. 1 illustrates an embodiment of a gas cooler 10 including a plate heat exchanger 12 having a heat exchange portion 16 and a connecting portion 14. The heat exchange portion 16 has an essentially circular shape when viewed from above. The connecting portion 14 has a shape of two partially circular portions extending from the circular shape of the heat exchange portion 16 when viewed from above. For the heat exchange portion 16 to efficiently work, openings are provided in the surface of the heat exchange portion 16 which allow gas, in particular air, to pass through the heat exchange portion 16.

The plate heat exchanger 12 includes a coolant inlet 18 through which coolant, in particular a mixture of water and glycol, flows into the plate heat exchanger 12 before heat exchange is performed and a coolant outlet 20 through which coolant flows out of the plate heat exchanger 12 after heat exchange has been performed. The coolant inlet 18 and coolant outlet 20 are disposed on the connecting portion 14 and include a coolant inlet port 19 and a coolant outlet port 21, illustrated in FIG. 1, to which a coolant supply line and a coolant discharge line of a heat pump circuit may be connected.

The plate heat exchanger 12 includes a plurality of plates 26 stacked together. Gaps through which coolant flows are formed between the plates 26. The coolant flow entering the plate heat exchanger 12 through the coolant inlet 18 has a lower temperature than the coolant flow exiting the plate heat exchanger 12 through the coolant outlet 20 because the coolant is heated up in the heat exchange portion 16 of the heat exchanger 12.

FIG. 2 depicts the embodiment of the gas cooler 10 of FIG. 1, where a top cover of the plate heat exchanger 12 and the coolant inlet port 19 and coolant outlet port 21 are omitted to illustrate an internal structure of the heat exchanger 12.

In the connecting portion 14, the coolant inlet 18 and the coolant outlet 20 allow the coolant to enter and leave the heat exchange portion 16. As shown in FIG. 2, a recess 24 or cut-out is formed in the connecting portion 14 of the plate heat exchanger 12 in a few uppermost plates 26 between the coolant inlet and the coolant outlet. This recess 24 or cut-out enables coolant to directly flow from the coolant inlet 18 to the coolant outlet 20, thereby bypassing the heat exchange portion 16 of the heat exchanger 12.

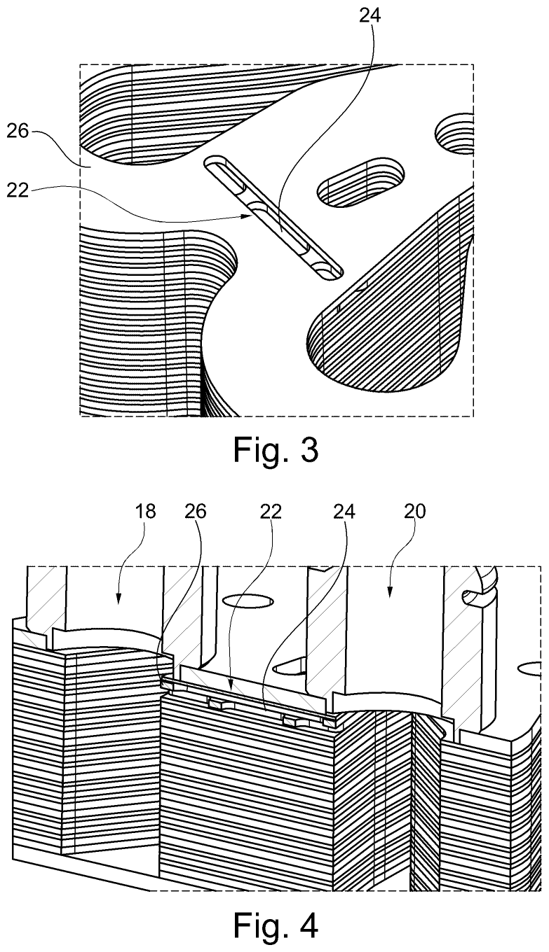

FIG. 3 illustrates an enlarged view of a portion of the preferred plate heat exchanger 12 of FIGS. 1 and 2 and particularly the recess 24 or cut-out in the uppermost few plates 26. FIG. 4 illustrates an enlarged sectional view of the embodiment illustrated in FIG. 3. The recess 24 or cut-out is formed in the two uppermost adjacent plates 26 of the connecting portion 14. As a result, a bypass line 22 is formed between the coolant inlet 18 and the coolant outlet 20.

If the bypass line is formed in the uppermost plates 26 of the plate heat exchanger 12, i.e., the plates closest to the coolant inlet port 19 and coolant outlet port 21, the bypass line allows for very effectively bypassing the heat exchange portion 16 where the heat exchange is predominantly effected. In other words, the bypass line 22 of this embodiment allows a portion of the coolant that has not yet been subject to heat exchange within the plate heat exchanger 12, in particular the heat exchange portion 16 to flow through the bypass line 22 and mix with the coolant exiting the heat exchange portion 16 after having been subject to heat exchange. Thereby, the temperature of the coolant coming from the heat exchange portion 16 and exiting the heat exchanger 12 can be lowered by mixing the coolant from the bypass line 22 and the coolant from the heat exchange portion 16.

The coolant outlet temperature can thereby be set as the mixing temperature of the partial volume flows through the heat exchange portion 16 and the bypass line 22, respectively.

As can be taken from FIG. 4, the bypass line 22 is formed by a recess 24 or cut-out in two plates 26 with a labyrinth structure forcing the coolant to change levels when flowing through the bypass line 22 from the coolant inlet 18 to the coolant outlet 20. Providing the bypass line as a recess 24 or cut-out in just one or a few plates of the plate heat exchanger and by redirecting the path several times, the bypass line can have a large flow cross section and be insensitive to dirt particles so that the gas cooler becomes particularly reliable.

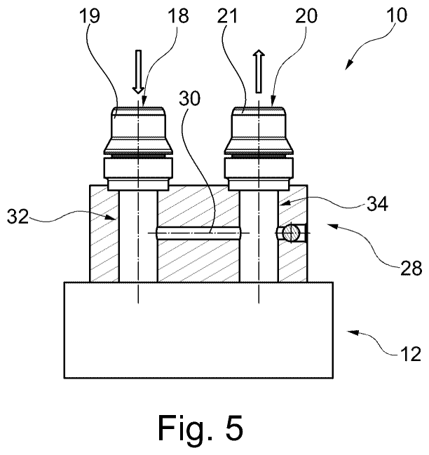

FIG. 5 illustrates a second embodiment of a preferred gas cooler. According to this alternative configuration, a connection block 28 is interposed between the plate heat exchanger 12 and the coolant inlet port 19 and coolant outlet port 21, which are similar to the plate heat exchanger 12 and the coolant inlet port 19 and coolant outlet port 21 described above. The connection block 28 may be attached to the plate heat exchanger 12 by at least one screw or may be soldered to the plate heat exchanger 12. Also other means to connect the connection block 28 to a plate heat exchanger 12 are possible. The connection block 28 may be made of aluminum or plastic, but also of other material.

Inside the connection block 28, a coolant supply passage 32 is formed connecting the coolant inlet port 19 with the connecting portion 14 of the plate heat exchanger 12 as an extended coolant inlet 18. Similarly, a coolant discharge passage 34 is formed inside the connection block 28 to connect the coolant outlet port 21 with the connecting portion 14 of the plate heat exchanger 12 as an extended coolant outlet 20.

Further, a bypass line 30 is formed within the connection block 28. The bypass line 30 connects the coolant supply passage 32 with the coolant discharge passage 34 so as to allow a portion of the coolant flow in the coolant supply passage 32 to bypass the heat exchanger 12 and mix with the coolant flow in the coolant discharge passage 34 coming from the heat exchanger 12.

Also in this embodiment, the coolant outlet temperature can thereby be set as the mixing temperature of the partial volume flows through the heat exchanger 12 and the bypass line 30, respectively.

### LIST OF REFERENCE SIGNS

10 gas cooler
12 heat exchanger
14 connecting portion
16 heat exchange portion
18 coolant inlet
19 coolant inlet port
20 coolant outlet
21 coolant outlet port
22 bypass line
24 recess
26 plate
28 connection block
30 bypass line
32 coolant supply passage
34 coolant discharge passage

What is claimed is:

1. A gas cooler for a battery electric vehicle, the gas cooler comprising:
a heat exchanger having a connecting portion and a heat exchange portion, the connecting portion further comprising:
a coolant inlet to allow a coolant to enter the heat exchanger, and
a coolant outlet to allow the coolant to exit the heat exchanger, wherein the gas cooler further comprises a first bypass line configured to redirect a portion of the coolant from the coolant inlet to the coolant outlet, thereby bypassing the heat exchange portion of the heat exchanger.

2. The gas cooler according to claim 1, wherein the heat exchanger is a plate heat exchanger.

3. The gas cooler according to claim 2, wherein the first bypass line is formed as a recess or cut-out in at least one plate of the plate heat exchanger, the recess or cut-out fluidly connecting the coolant inlet with the coolant outlet.

4. The gas cooler claim 1, further comprising a connection block having a second bypass line fluidly connecting the coolant inlet with the coolant outlet, thereby bypassing the heat exchanger.

5. The gas cooler according to claim 1, wherein the gas cooler is configured for the coolant being a mixture of water and glycol.

6. The gas cooler according to claim 1, wherein the heat exchange portion has a circular shape when viewed from above.

7. The gas cooler according to claim 1, wherein openings are provided in the heat exchange portion to allow gas to pass through the heat exchange portion.

8. The gas cooler according to claim 1, wherein the connecting portion has a shape of two partially circular portions extending from the heat exchange portion when viewed from above.

9. The gas cooler according to claim 4, wherein the coolant inlet includes a coolant inlet port for connecting a coolant supply line of a heat pump circuit to the coolant inlet.

10. The gas cooler according to claim 9, wherein the coolant outlet further comprises a coolant outlet port for connecting a coolant discharge line of the heat pump circuit to the coolant outlet.

11. The gas cooler according to claim 4, wherein the connection block is produced from aluminum.

12. The gas cooler according to claim 4, wherein the connection block is produced from plastic.

13. The gas cooler according to claim 3, wherein the recess or cut-out is formed in the connecting portion of at least two uppermost plates of the plate heat exchanger between the coolant inlet and the coolant outlet.

14. The gas cooler according to claim 10, wherein a coolant supply passage is formed connecting the coolant inlet port with the connecting portion of the plate heat exchanger, wherein a coolant discharge passage is formed inside the connection block to connect the coolant outlet port with the connecting portion of the plate heat exchanger, and wherein the second bypass line connects the coolant supply passage with the coolant discharge passage to allow a portion of the coolant to flow in the coolant supply passage to bypass the heat exchanger and mix with a flow of the coolant in the coolant discharge passage coming from the heat exchanger.

15. The gas cooler according to claim 14, wherein the coolant supply passage is formed connecting the coolant inlet port with the connecting portion of the plate heat exchanger to form the coolant inlet as extended.

16. The gas cooler according to claim 14, wherein the coolant discharge passage is formed inside the connection block to connect the coolant outlet port with the connecting portion of the plate heat exchanger to form the coolant outlet as extended.

17. The gas cooler according to claim 13, wherein the recess or cut-out has an elongate rounded rectangular shape.

18. The gas cooler according to claim 3, wherein the first bypass line is formed with a labyrinth structure forcing the coolant to change levels when flowing through the first bypass line from the coolant inlet to the coolant outlet.
